(19) United States
(12) Patent Application Publication
(10) Pub. No.: US 2025/0050790 A1
(43) Pub. Date: Feb. 13, 2025

(54) SEAT SYSTEM

(71) Applicant: Adient US LLC, Plymouth, MI (US)

(72) Inventors: William Shawn BREWER, Plymouth, MI (US); Michael G. MADDELEIN, Northville, MI (US)

(73) Assignee: Adient US LLC, Plymouth, MI (US)

(21) Appl. No.: 18/720,139

(22) PCT Filed: Jan. 24, 2023
(86) PCT No.: PCT/US2023/061145

§ 371 Date: Jun. 14, 2024

Related U.S. Application Data
(60) Provisional application No. 63/267,267, filed on Jan. 28, 2022.

(51) Int. Cl. B60N 2/225; B60N 2/12

(52) U.S. Cl. CPC B60N 2/2251; B60N 2/12

(57) ABSTRACT

A seat system for a vehicle may have a seat base assembly and a seat back assembly. Each of the seat base assembly and the seat back assembly may include at least one actuator assembly at least partially disposed therein. The actuator assembly may be configured to selectively adjust at least one of the seat base assembly and the seat back assembly to reach a desired angle, position, and/or height. The actuator assembly may include a motor assembly and a gear assembly, wherein the motor assembly includes a printed circuit board stator.

### FIELD

The presently disclosed subject matter relates to a seat system, and more particularly to a powered seat system.

### BACKGROUND

Conventional seat systems, particularly seat systems employed in a vehicle, include a seat back assembly connected to a seat base assembly and a headrest assembly. Each of the seat back assembly and the seat base assembly may include an electric motor for positioning thereof. More particularly, one electric motor is employed to recline and sit-up the seat back assembly and another electric motor is employed to slideably move the seat base assembly forward and rearward. Other motors may be used to lift the seat base assembly and/or provide a cushion length, or shape, adjustment.

Typically, the electric motors are brushed direct-current (DC) motors. Power drive speed of the typical brushed DC motor is based upon applied load and voltage. A gearing system connected to the DC motors have a lower operational efficiency, increasing a cost and a mass of the DC motor needed for the vehicle. Accordingly, the DC motors require an extended package size, occupying valuable space within the seat system and/or the vehicle. Another drawback of the typical brushed DC motor is that it generates inconsistent operation speed and sound unless electronically controlled.

Accordingly, it would be desirable to produce a powered seat system for a vehicle, which simplifies manufacturability and minimizes noise output, mass, packaging size, and costs, while improving performance.

### SUMMARY

In concordance and agreement with the present disclosure, a powered seat system for a vehicle, which simplifies manufacturability and minimizes noise output, mass, packaging size, and costs, while improving performance, has surprisingly been discovered.

In one embodiment, the seat system may have a seat base assembly and a seat back assembly coupled to the seat base assembly. The system may also have at least one actuator assembly at least partially disposed within the seat base assembly or the seat back assembly. The at least one actuator assembly may comprises a motor assembly and a gear assembly. The motor assembly may have a printed circuit board stator.

In another aspect, the motor assembly and the gear assembly may be concentrically arranged about a common axis.

In another aspect, the gear assembly may comprise a housing with a first cavity and a second cavity, wherein the cavities are at least partially separated by a radially extending inner portion, wherein a planetary gear set is located in the first cavity, the planetary gear set comprising a sun gear, a plurality of planet gears meshed with the sun gear and mounted on a carrier, wherein the carrier has an annular hub.

In another aspect, an armature shaft of the motor assembly may extend through and be rotationally coupled with the sun gear.

In another aspect, a first cycloid gear may be mounted on the annular hub for rotation therewith, wherein the first cycloid gear may be meshed with a plurality of teeth on an inner surface of the second cavity, and wherein the first cycloid gear may be connected to a second cycloid gear within the second cavity.

In another aspect, an actuator may be located within an aperture of the second cycloid gear for rotation therewith, and wherein the actuator may be connected to the seat base assembly or the seat back assembly.

In another aspect, the gear assembly may comprise a housing with a single cavity, wherein a planetary gear set may be located in the cavity, the planetary gear set may comprise a sun gear, a plurality of planet gears meshed with the sun gear and mounted on a carrier.

In another aspect, a rotatable ring is in meshed engagement with the planet gears within the cavity, wherein the ring comprises an axially extending annular hub and a bore formed therethrough.

In another aspect, a guide plate may be disposed adjacent the ring to support the axial position of the planetary gear set and the ring within the cavity, wherein the guide plate has a central aperture.

In another aspect, a cycloid gear may be located adjacent the guide plate and on the axially extending annular hub of the ring for rotation therewith.

In another aspect, the cycloid gear may be in meshed engagement with a plurality of teeth of a gear and pinion mechanism to rotate the gear and pinion mechanism within the cavity.

In another aspect, the gear and pinion mechanism may comprise a pinion that extends through a central bore in the cycloid gear, the central aperture of the guide plate, the bore in the ring and at least partially within an armature shaft of the motor assembly.

In another aspect, the gear and pinion mechanism may comprise an annular hub adapted as an actuator connected to the seat base assembly or the seat back assembly.

### BRIEF DESCRIPTION OF THE DRAWINGS

The accompanying drawings are incorporated herein as part of the specification. The drawings described herein illustrate embodiments of the presently disclosed subject matter, and are illustrative of selected principles and teachings of the present disclosure. However, the drawings do not illustrate all possible implementations of the presently disclosed subject matter, and are not intended to limit the scope of the present disclosure in any way.

FIG. 1 is a side perspective view of a seat system according to the presently described subject matter, wherein the seat system includes a seat base assembly, a seat back assembly, and a headrest assembly;

FIG. 2 is a fragmentary perspective view of a seat frame of the seat system of FIG. 1, wherein an actuator assembly is coupled to a seat base frame portion and another actuator assembly is coupled to a seat back frame portion;

FIG. 3 is an enlarged perspective view of the actuator assembly coupled to the seat back frame portion of the seat system of FIG. 1;

FIG. 4 is an enlarged perspective view of the actuator assembly coupled to the seat base frame portion of the seat system of FIG. 1;

FIG. 5 is an exploded view of a motor assembly of the actuator assembly of FIGS. 3 and 4 according to an embodiment of the presently described subject matter;

FIG. 6 is a cross-sectional view of the motor assembly of FIG. 5;

FIG. 7 is a perspective view of the motor assembly of FIGS. 5 and 6;

FIG. 8 is a front elevational view of various embodiments of a printed circuit board assembly that may be employed in the motor assembly of FIGS. 5-7;

FIG. 9 is a partially exploded view of the actuator assembly shown in FIG. 3;

FIG. 10 is a cross-sectional view of the actuator assembly shown in FIGS. 3 and 9;

FIG. 11 is a partially exploded view of another embodiment of an actuator assembly shown in FIG. 4; and

FIG. 12 is a cross-sectional view of the actuator assembly shown in FIG. 11.

### DETAILED DESCRIPTION

It is to be understood that the presently disclosed subject matter may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

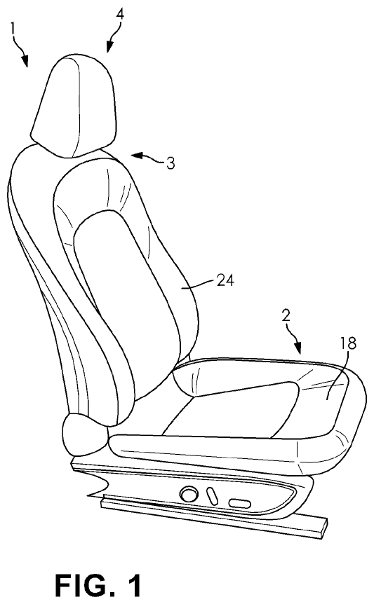

FIG. 1 shows a seat system 1 for a motor vehicle (not depicted) according to an embodiment of the presently described subject matter. The seat system 1 may comprise a seat base assembly 2, a seat back assembly 3, and a headrest assembly 4. The seat back assembly 3 may be coupled to the seat base assembly 2 and the headrest assembly 4. In certain embodiments, the seat base assembly 2 may be movable relative to a floorboard of the vehicle, the seat back assembly 3 may be movable relative to the seat base assembly 2, and the headrest assembly 4 may be movable relative to the seat back assembly 3. The seat base assembly 2 may be configured to support a buttock portion and leg portion of an occupant. The seat back assembly 3 may be configured to support a back region of the occupant.

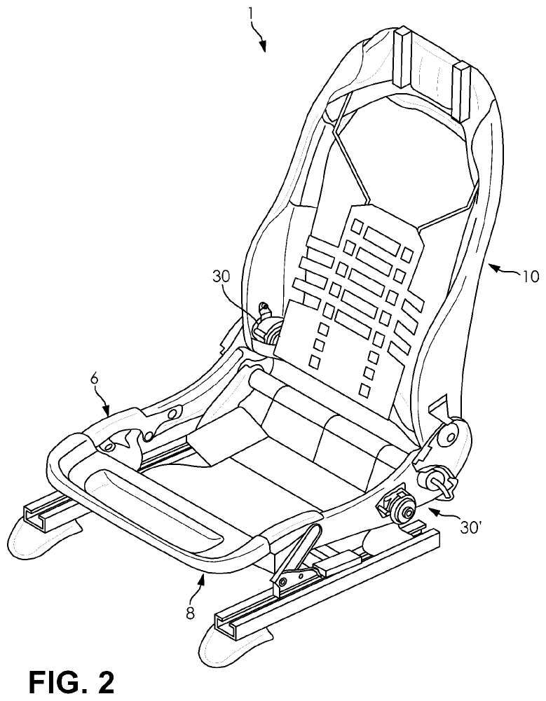

As best seen in FIG. 2, the seat system 1 may also include a seat frame 6. The seat frame 6 may comprise a seat base frame portion 8, a seat back frame portion 10, and a headrest frame portion (not depicted). It is understood that the frame portions may be coupled together using any suitable means as desired. It is further understood that any suitable material may be employed to produce the frame portions as desired. For example, each of the frame portions may be formed from a rigid metal material.

In certain embodiments, a cushioning member (not depicted) may be disposed on the seat base frame portion and a seat covering or trim 18 disposed over the cushioning member. Similarly, the seat back assembly 3 may include a cushioning member (not depicted) disposed on the seat back frame portion and a seat covering or trim 24 disposed over the cushioning member.

The seat base assembly 2 of the seat system 1 may be coupled to at least one track mounted on a floor inside the vehicle, which allows an occupant to selectively move the seat system 1 forward or rearward on the at least one track to a desired position. In certain embodiments, the seat base assembly 2 may also be raised and lowered relative to the floor of the vehicle to a height desired by an occupant. The seat back assembly 3, moreover, may be inclined to a desired angle of the occupant using one or more recliners that hinge the seat back assembly 3 and the seat base assembly 2 to each other.

The occupant may initiate a tilt-and-slide mode by way of an input control. For example, the occupant presses a button of a power switch mounted on the seat base assembly 2 and/or the seat back assembly 3. In response to the input control, the seat system 1 may undergo a tilt to the desired angle, a slide to a desired position, and/or be raised or lowered to a desired height. Additionally, in response to the input control, the seat system 1 may also undergo a lumbar adjustment and/or a bolster adjustment for cushion and back to desired levels. It is understood that the desired angle, forward/rearward position, height, lumbar position, and/or bolster position may be any angle, forward/rearward position, height, lumbar position, and/or bolster position as desired by the occupant. In some embodiments, the seat system 1 transitions essentially simultaneously into the desired angle, forward/rearward position, height, lumbar position, and/or bolster position. For example, a controller (not depicted) of the seat system 1 may initiate the tilting essentially at the same time as the slide, and/or essentially at the same time as the raising or lowering, and/or essentially at the same time as the lumbar adjustment, and/or essentially at the same time as the bolster adjustment.

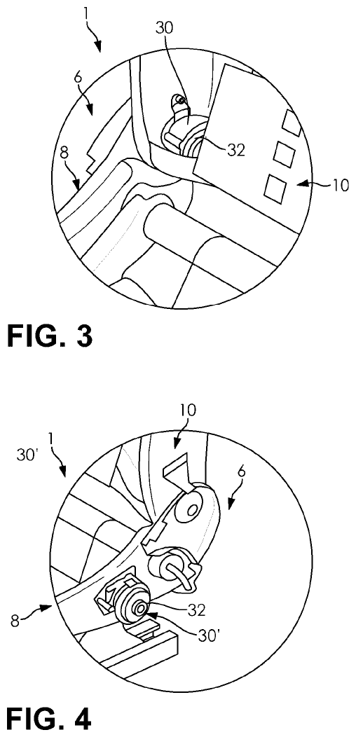

The controller may be in electrical communication with at least one actuator assembly 30, 30′ shown in FIGS. 2-4. Each of the actuator assemblies 30, 30′ may be configured to selectively adjust at least one of the seat base assembly 2, the seat back assembly 3, a lumbar region, and/or a bolster region in the cushion and back to reach the desired angle, forward/rearward position, height, lumbar position, and/or bolster position. It is understood that the actuator assemblies 30, 30′ may be employed in various other areas and regions of the seat system 1 as well as various other components of the seat system 1 to provide a desired comfort level to the occupant.

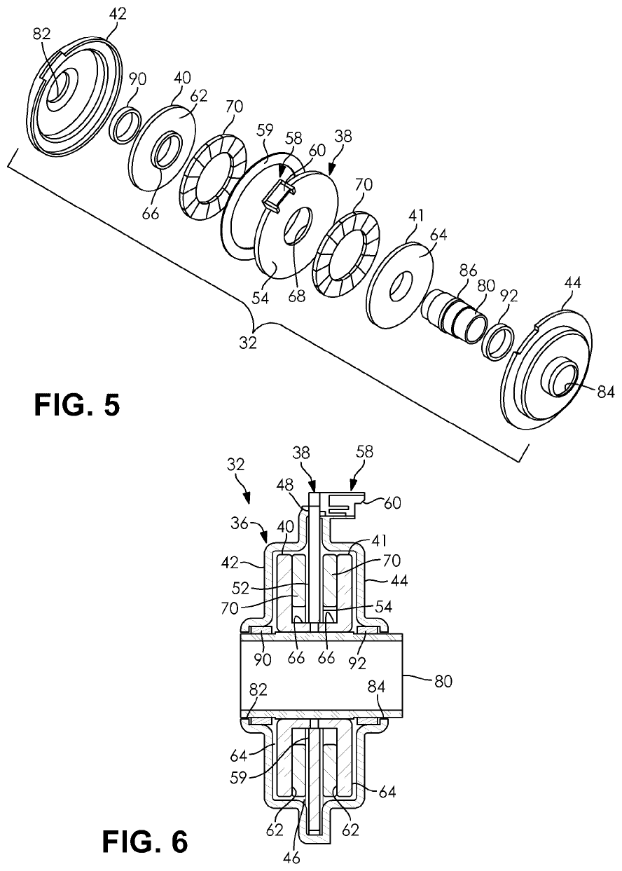

In certain embodiments, the actuator assemblies 30, 30′ may include a motor assembly 32, 32′. In the preferred embodiment depicted in FIGS. 5-7, the motor assembly 32 may be comprised of a housing 36, a printed circuit board (PCB) stator 38, and a pair of rotors 40, 41 disposed therein. More or less rotors may be employed in the motor assembly 32 if desired.

As more clearly shown in FIG. 6, the housing 36 may be formed from a first housing portion 42 and a second housing portion 44, which cooperate together to define a cavity 46 and an aperture 48. More or less housing portions than shown may be employed if desired. As illustrated, each of the housing portions 42, 44 may have a generally disc shape. It is understood, however, that the housing portions 42, 44 may have any suitable shape, size, and configuration. It is also understood that each of the housing portions 42, 44 may be produced from any suitable material such as a plastic material, a metal material, and combinations thereof, for example.

In a preferred embodiment, the PCB stator 38 may be a printed circuit board (PCB). The PCB stator 38 has a generally disc shape with a substantially planar first face 52 and an opposing substantially planar second face 54. A winding 56, shown in FIG. 8, may be integrated with the PCB stator 38 through a PCB manufacturing process to produce a PCB stator assembly 58. As best seen in FIG. 6, the winding 56 may be located on at least one of the faces 52, 54 of the PCB stator 38 in any suitable configuration. A ring 59 may be disposed on at least one face 52, 54 of the PCB stator 38.

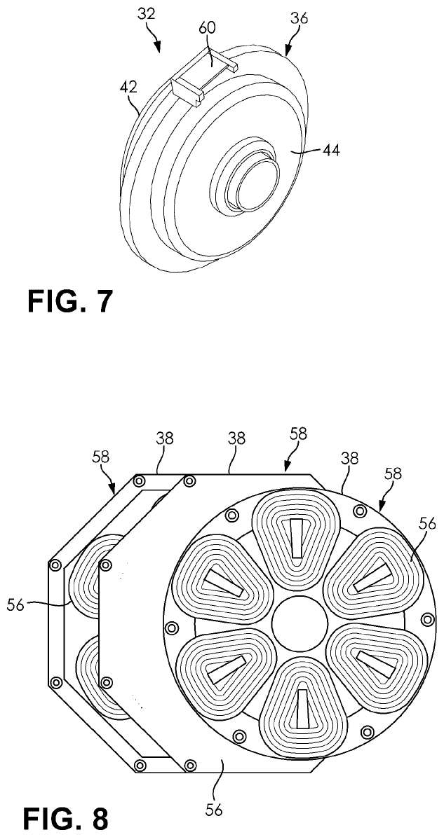

The PCB stator assembly 58 may further include an electrical connector 60 coupled thereto and in electrical communication with the winding 56. The electrical connector 60 may be configured to receive a wiring harness (not depicted) therein, which facilitates a flow of electrical current from a power source (not depicted), through the wiring harness and electrical connector, to the winding 56. As illustrated in FIG. 7, the electrical connector 60 may be disposed through the aperture 48 formed in the housing 36.

Referring back to FIG. 5, the rotors 40, 41 each have a generally disc shape with a substantially planar first face 62 and an opposing substantially planar second face 64. An annular hub 66 may be formed on at least one of the faces 62, 64. The annular hub 66 may be formed to axially extend from the at least one of the faces 62, 64 of the rotors 40, 41 into a central bore 68 formed in the PCB stator 38. The rotors 40, 41 may be produced from an iron material, for example. One of the rotors 40, 41 may be disposed adjacent the first face 52 of the PCB stator 38 and another one of the rotors 40, 41 may be disposed adjacent the second face 54 of the PCB stator 38. An annular array of magnets 70 (e.g. neodymium magnets) may be disposed between the PCB stator 38 and each of the rotors 40, 41.

As best seen in FIGS. 5 and 6, the motor assembly 32 further includes an armature shaft 80. The armature shaft 80 may be disposed through the central bore 68 of the PCB stator 38 and central bores 82, 84, formed in the housing portions 42, 44, respectively. The armature shaft 80 may be rotatably coupled to the annular hubs 66 of the rotors 40, 41 for rotation therewith.

The armature shaft 80, moreover, may also include an annular protuberance 86 formed around a circumferential surface of the armature shaft 80. The protuberance 86 may be disposed in an interstice formed between the annular hubs 66 to militate against an axial movement of the armature shaft 80 within the motor assembly 32.

A pair of bushings 90, 92 may be disposed between the armature shaft 80 and the housing portions 42, 44 to permit a rotational movement of the armature shaft 80 within the motor assembly 32. It is understood that the bushing may be formed from any suitable material such as an oil impregnated bronze material, for example.

Such configuration of the housing 36, the PCB stator 38, and the rotors 40, 41, provides a generally flattened motor assembly 32, minimizing a size and volume thereof yet providing a simplified structure and a cost reduction.

When the winding 56 is not energized, attractive forces between the PCB stator 38 and the magnets 70 are balanced, the motor assembly 32 is in a stable state, and the rotors 40, 41 are in a stationary state. When the winding 56 is energized, a magnetic field is formed under a joint action with the magnets 70, the rotors 40, 41, and the PCB stator 38, and more preferably, the magnets 70 are deflected under an action of the magnetic field. Therefore, the balance between the PCB stator 38, the rotors 40, 41, and the magnets 70 is broken, and the deflection of the magnets 70 cause the rotors 40, 41 to move in a rotational direction. Since the armature shaft 80 is rotatably coupled to the rotors 40, 41, the rotation of the rotors 40, 41 further drives the armature shaft 80 to rotate. The rotors 40, 41 continue to rotate, until a new balance point between the PCB stator 38, the rotors 40, 41, and/or the magnets 70 is reached. Therefore, the rotation movement, and lack thereof, of the armature shaft 80 of the motor assembly 32 is caused by respective energization and de-energization of the winding 56.

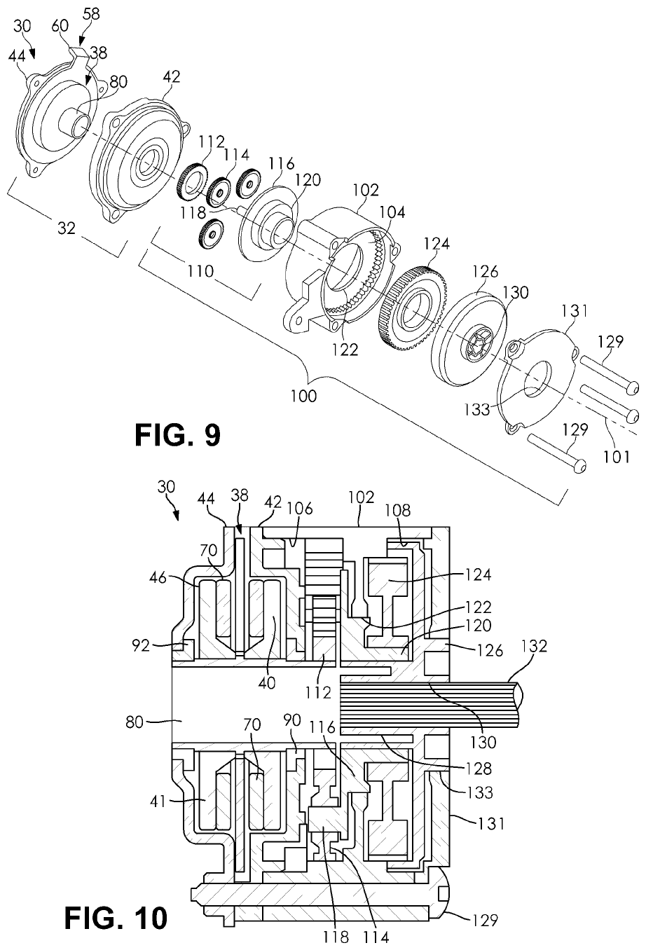

In certain embodiments shown in FIGS. 9 and 10, the actuator assembly 30 may further include a gear assembly 100. The motor assembly 32 and the gear assembly 100 may be concentrically arranged about a common axis 101. The gear assembly 100 may include a housing 102 having a radially extending inner portion 104, which defines a first cavity 106 and a second cavity 108. It is understood that the housing 102 may be produced from any suitable material such as a plastic material, a metal material, and combinations thereof, for example.

In one embodiment, a planetary gear set 110 may be disposed in the first cavity 106. The planetary gear set 110 may include a sun gear 112, a plurality of planet gears 114 disposed about the sun gear 112, and a carrier 116 on which the planet gears 114 may be mounted. The sun gear 112 may be rotatably coupled to the armature shaft 80 for rotation therewith. A rotational movement of the sun gear 112 causes a rotational movement of the planet gears 114 that are in meshed engagement with the sun gear 112. The carrier 116 may include at least one stem 118 configured to receive a respective one of the planet gears 114 thereon. An annular hub portion 120 of the carrier 116 may be disposed through a center bore 122 formed in the inner portion 104.

A first cycloid gear 124 may be disposed on a portion of the annular hub portion 120 of the carrier 116 within the second cavity 108. As such, the first cycloid gear 123 is rotatable with the carrier 116. The first cycloid gear 124 may be in meshed engagement with at least one of a plurality of gear teeth formed on an inner surface of the second cavity 108 and a second cycloid gear 126, thereby causing a rotational movement of the second cycloid gear 126. The second cycloid gear 126 may also be disposed within the second cavity 108 of the housing 102. As illustrated, the second cycloid gear 126 may include an annular hub 128 and a central bore 130 formed therethrough.

A cover plate 131 may be disposed adjacent the second cycloid gear 126 and secured to the housing 102. Various methods may be employed to attached the cover plate 131 to the housing 102 such as by mechanical fasteners 129, for example.

An actuator (not depicted) may be disposed through an aperture 133 formed in the cover plate 131 and at least partially received in the armature shaft 80 of the motor assembly 32 and the central bore 130 of the second cycloid gear 126. In a preferred embodiment, the actuator is rotatably coupled to the second cycloid gear 126 for rotation therewith. In certain embodiments, the armature shaft 80 is generally hollow to allow the actuator to be disposed back through the motor assembly 32 and the gear assembly 100. In certain embodiments, the actuator is rotatably coupled to the second cycloid gear 126 for rotation therewith. The actuator may be employed to selectively adjust at least one of the seat base assembly 2 and the seat back assembly 3 to reach the desired angle, position, and/or height.

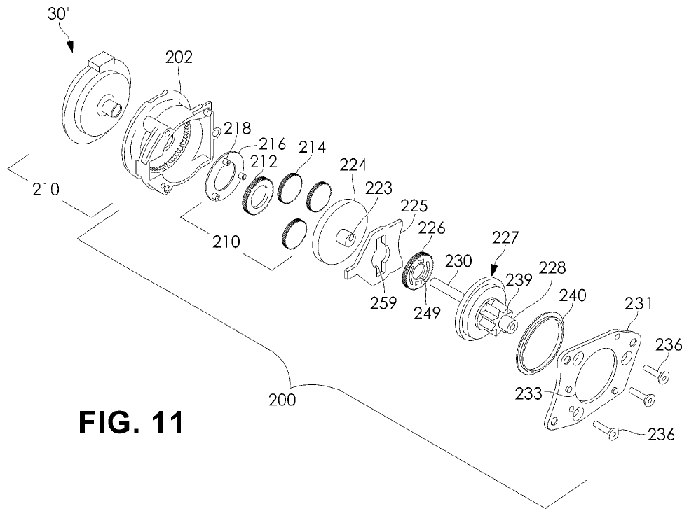

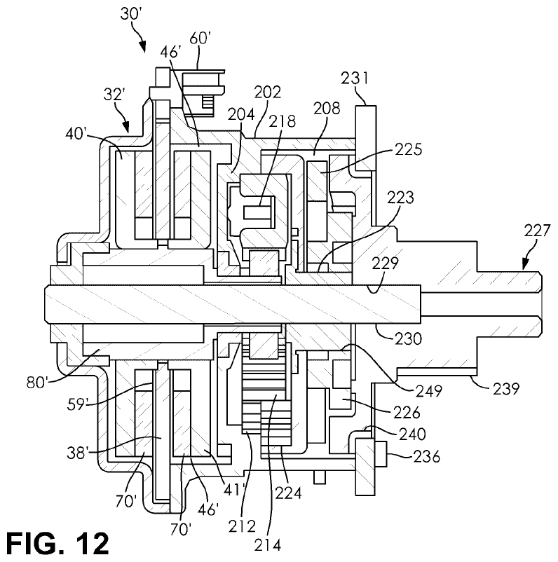

FIGS. 11-12 show another embodiment of an actuator assembly 30′ similar to that shown in FIGS. 9-10. Reference numerals for similar structure in respect of the description of FIGS. 9-10 are repeated in FIGS. 11-12 with a prime (′) symbol.

The actuator assembly 30′ may include a motor assembly 32′ and a gear assembly 200. As illustrated, the motor assembly 32′ and the gear assembly 200 may be concentrically arranged about a common axis 101′. The gear assembly 200 may include a housing 202 having a radially extending inner portion 204, which defines a portion of the cavity 46′ of the motor assembly 32′ and a cavity 208 for the gear assembly 200. Accordingly, the second housing portion 44 of the motor assembly 32′ may no longer be necessary. It is understood that the housing 202 may be produced from any suitable material such as a plastic material, a metal material, and combinations thereof, for example.

In one embodiment, a planetary gear set 210 may be disposed in the cavity 208. The planetary gear set 210 may include a sun gear 212, a plurality of planet gears 214 disposed about the sun gear 212, and a carrier 216 on which the planet gears 214 may be mounted. The sun gear 212 may be rotatably coupled to the armature shaft 80′ for rotation therewith. A rotational movement of the sun gear 212 causes a rotational movement of the planet gears 214 that are in meshed engagement with the sun gear 212. The carrier 216 may include at least one stem 218 configured to receive a respective one of the planet gears 214 thereon.

A rotatable ring 224 may be disposed adjacent a portion of the planetary gear set 210 within the cavity 208. More particularly, the ring 224 may be in meshed engagement with the planet gears 214, causing a rotational movement of the ring 224. The ring 224 may include an axially extending annular hub 223 and a bore 229 formed therethrough. A guide plate 225 may be disposed adjacent the ring 224 to support and/or maintain an axial position of at least one of the planetary gear set 210 and the ring 224 within the cavity 208. A cycloid gear 226 may be disposed adjacent the guide plate 225 and on the annular hub 223 of the ring 224. In certain embodiments, the cycloid gear 226 is rotatably coupled to the annular hub 223 of the ring 224, causing a rotational movement therewith. The cycloid gear 226 may be in meshed engagement with a plurality of gear teeth formed on an inner surface of a gear and pinion mechanism 227. Thus, the rotational movement of the cycloid gear 226 causes a rotational movement of the pinion and gear mechanism 227.

The gear and pinion mechanism 227 may also be at least partially disposed within the cavity 208 of the housing 202. As illustrated, the gear and pinion mechanism 227 may include a pinion 230 and an axially extending annular hub 228 having a plurality of gear teeth 239 formed thereon. The pinion 230 may axially extend through a central bore 249 formed in the cycloid gear 226, an aperture 259 formed in the guide plate 225, the central bore 229 of the ring 224 and at least partially received in the armature shaft 80′ of the motor assembly 32′. In certain embodiments, the armature shaft 80′ is generally hollow to allow the pinion 230 to be disposed back through the motor assembly 32′ and the gear assembly 200.

A mounting plate 231 may be disposed adjacent the gear and pinion mechanism 227 and secured to the housing 202. Various methods may be employed to attached the mounting plate 231 to the housing 202 such as by mechanical fasteners 236, for example. The mounting plate 231 may be configured to secure the actuator assembly 30′ to a portion of the seat system 1. A bushing 240 may be disposed between the gear and pinion mechanism 227 and at least one of the housing 202 and the mounting plate 231. The annular hub 228 of the gear and pinion mechanism 227 may function as an actuator 232. The actuator 232 may be disposed through an aperture 233 formed in the mounting plate 231. The actuator 232 may be employed to selectively adjust at least one of the seat base assembly 2 and the seat back assembly 3 to reach the desired angle, position, and/or height.

It should be appreciated that the actuator assemblies 30, 30′ are advantageous as they reduce mass, improve operation sound, improve EMC performance, integrated memory and motor controls, reduce ECU requirements, reduce costs, provide constant output speed independent of load, consistent operation speed and sound, improved durability, reduce number and complexity of mechanical components, memory function requires only programming (no hardware), small package space required, and ability to control motor torque.

While various embodiments have been described above, it should be understood that they have been presented by way of example, and not limitation. It will be apparent to persons skilled in the relevant arts that the disclosed subject matter may be embodied in other specific forms without departing from the spirit or essential characteristics thereof. The embodiments described above are therefore to be considered in all respects as illustrative, not restrictive.

What is claimed is:

1. A seat system, comprising:
a seat base assembly;
a seat back assembly coupled to the seat base assembly; and
at least one actuator assembly at least partially disposed within the seat base assembly or the seat back assembly,
wherein the at least one actuator assembly comprises a motor assembly and a gear assembly,
wherein the motor assembly has a printed circuit board stator.

2. The seat system of claim 1, wherein the motor assembly and the gear assembly are concentrically arranged about a common axis.

3. The seat system of claim 1, wherein the gear assembly comprises a housing with a first cavity and a second cavity, wherein the cavities are at least partially separated by a radially extending inner portion, wherein a planetary gear set is located in the first cavity, the planetary gear set comprising a sun gear, a plurality of planet gears meshed with the sun gear and mounted on a carrier, wherein the carrier has an annular hub.

4. The seat system of claim 3, wherein an armature shaft of the motor assembly extends through and is rotationally coupled with the sun gear.

5. The seat system of claim 3, wherein a first cycloid gear is mounted on the annular hub for rotation therewith, wherein the first cycloid gear is meshed with a plurality of teeth on an inner surface of the second cavity, and wherein the first cycloid gear is connected to a second cycloid gear within the second cavity.

6. The seat system of claim 5, wherein an actuator is located within an aperture of the second cycloid gear for rotation therewith, and wherein the actuator is connected to the seat base assembly or the seat back assembly.

7. The seat system of claim 1, wherein the gear assembly comprises a housing with a single cavity, wherein a planetary gear set is located in the cavity, the planetary gear set comprising a sun gear, a plurality of planet gears meshed with the sun gear and mounted on a carrier.

8. The seat system of claim 7, wherein a rotatable ring is in meshed engagement with the planet gears within the cavity, wherein the ring comprises an axially extending annular hub and a bore formed therethrough.

9. The seat system of claim 8, wherein a guide plate is disposed adjacent the ring to support the axial position of the planetary gear set and the ring within the cavity, wherein the guide plate has a central aperture.

10. The seat system of claim 8, wherein a cycloid gear is located adjacent the guide plate and on the axially extending annular hub of the ring for rotation therewith.

11. The seat system of claim 10, wherein the cycloid gear is in meshed engagement with a plurality of teeth of a gear and pinion mechanism to rotate the gear and pinion mechanism within the cavity.

12. The seat system of claim 11, wherein the gear and pinion mechanism comprises a pinion that extends through a central bore in the cycloid gear, the central aperture of the guide plate, the bore in the ring and at least partially within an armature shaft of the motor assembly.

13. The seat system of claim 11, wherein the gear and pinion mechanism comprises an annular hub adapted as an actuator connected to the seat base assembly or the seat back assembly.
